(19) United States
(12) Patent Application Publication
(10) Pub. No.: US 2013/0068076 A1
(43) Pub. Date: Mar. 21, 2013

(54) METHOD AND DEVICE FOR ADJUSTING THE CUTTING GAP OF SLICING DEVICE

(71) Applicants: Jorg Schmeiser, Wiggensbach (DE); Josef Mayer, Memmingerberg (DE)

(72) Inventors: Jorg Schmeiser, Wiggensbach (DE); Josef Mayer, Memmingerberg (DE)

(73) Assignee: CFS BUHL GMBH, Kempten, DE (DE)

(21) Appl. No.: 13/702,149

(22) PCT Filed: Jun. 14, 2011
(86) PCT No.: PCT/EP11/02909

§ 371 Date: Dec. 5, 2012

(30) Foreign Application Priority Data
Jun. 11, 2010 (DE) 10 2010 023 405.2
Aug. 13, 2010 (DE) 10 2010 034 360.9

(51) Int. Cl. B26D 7/26

(52) U.S. Cl. CPC B26D 7/2635
USPC 83/13; 83/707

(57) ABSTRACT

The invention relates to a method for adjusting the cutting gap in a slicing device for cutting food products, wherein the slicing device comprises a rotationally driven blade, a cutting edge, and an adjusting device, which moves the blade toward the cutting edge or away from the cutting edge perpendicularly to the cutting edge, wherein the blade is first moved by the adjusting device until the blade touches the cutting edge and then a desired distance between the blade and the cutting edge is set by the adjusting device. The invention further relates to a device for adjusting the cutting gap of a slicing device.

The present invention relates to a method for adjusting the cutting gap on a slicing device for cutting food products, wherein the slicing device has a rotatingly driven blade, a cutting edge and an adjusting device which moves the blade perpendicularly with respect to the cutting edge toward the cutting edge or away from said cutting edge, in which method the blade is first of all moved by the adjusting device until the blade contacts the cutting edge and a desired spacing between the blade and the cutting edge is then adjusted by the adjusting device. In addition, the present invention relates to a device for adjusting the cutting gap of a slicing device.

A method of this type is known from the prior art, for example from EP 1409210B1. The method described here, however, is comparatively expensive to carry out and often leads to unsatisfactory results.

Consequently, it was the object of the present invention to make available a method and a slicing device, neither of which have the disadvantages of the prior art.

The object is achieved with a method for adjusting a cutting gap on a slicing device for cutting food products, wherein the slicing device has a rotatingly driven blade, a cutting edge and an adjusting device which moves the blade perpendicularly with respect to the cutting edge toward the cutting edge or away from said cutting edge, in which method the blade is first of all moved by the adjusting device until the blade contacts the cutting edge and a desired spacing between the blade and the cutting edge is then adjusted by the adjusting device and in which method the lag error
of the rotational drive of the blade and/or
of the drive of the adjusting device which moves the blade perpendicularly with respect to the cutting edge,
   is determined when the blade contacts the cutting edge. The direction of rotation of the blade during the travel toward the blade is preferably effected in opposition to the direction of rotation in the cutting operation. This prevents damage to the blade cutting edge during the adjusting process.

The rotation of the blade during the adjusting process has substantial advantages compared to the prior art. It the blade is not rotationally moved during adjustment, there is only pointwise contact between the blade and the cutting edge at 2 points. Since said contact point can vary strongly depending on the relative position of the rotational axis of the blade with respect to the cutting edge and depending on the design of the cutting edge, a measurement according to the prior art only produces an inaccurate measurement. In contrast, when the blade is rotated during adjustment, preferably the entire overlap plane of the blade and the cutting edge is completely covered.

The statements made with respect to said object of the present invention apply equally to the other statements and vice versa.

The present invention relates to a method for adjusting the cutting gap on a slicing device. Using a slicing device of this type, blocks of food, for example, blocks of sausage, cheese or ham, are sliced into food slices. During the slicing, a rotatingly driven cutting blade and a cutting edge interact in a cutting manner. The cutting gap is the spacing between the cutting blade and a cutting edge. Said cutting gap has to be adjusted in a very precise manner. If it is too large, the products, at least in sections, are not cut but chopped. If it is too small, there is constant, unwanted contact between the cutting blade and the cutting edge, which incurs a high level of wear on the blade.

In the case of the method as claimed in the invention, it is now provided that the blade is displaced by an adjusting device perpendicularly with respect to the cutting edge up until the blade contacts the cutting edge. Proceeding from said contact position as the zero position, the cutting blade can then be moved by the adjusting device away from the cutting edge by a defined spacing which is just large enough such that the blade does not impact against the cutting edge or is not so large that it results in the products being chopped. Said spacing is the desired cutting gap.

According to a first embodiment of the present invention as claimed in the invention, the lag error of the rotational drive of the blade is determined when the cutting edge is contacted. During said adjustment, the cutting blade is rotated or it oscillates to and fro about its rotational axis. At the same time, the blade is moved by an adjusting device in a linear manner along its rotational axis in the direction of the cutting edge until it contacts said cutting edge. In particular, when the blade is driven rotatingly at a comparatively small torque, a lag error is set up when the blade contacts the cutting edge since the torque made available is not large enough to hold the required position demanded by a control means. The actual position of the blade is consequently lagging behind the required position. Said difference is designated as the lag error. Consequently, as soon as such a lag error occurs, the machine control knows that the blade has contacted the cutting edge and the linear adjusting of the blade in the direction of the cutting edge is stopped. Proceeding from the contact position as the zero position, the cutting blade can than be moved away from the cutting edge by a defined spacing which is just large enough such that the blade does not impact against the cutting edge or is not so large that it results in the products being chopped. Said spacing is the desired cutting gap.

In the case of an additional or alternative embodiment of the present invention, the lag error of the drive of the adjusting device which displaces the cutting blade perpendicularly with respect to the cutting plane is determined. As soon as the blade contacts the cutting edge, a lag error occurs at the drive of the adjusting device since the required position of the drive demanded by a control means cannot be held. The actual position of the blade is consequently lagging behind the required position. Said difference is designated as the lag error. Consequently, as soon as such a lag error occurs, the machine control knows that the blade has contacted the cutting edge. The drive is then immediately switched off. Proceeding from said contact position as the zero position, the cutting blade can then be moved away from the cutting edge by a defined spacing which is just large enough such that the blade does not impact against the cutting edge or is not so large that it results in the products being chopped. Said spacing is the desired cutting gap. The blade preferably oscillates to and fro when the blade is displaced.

The statements made with respect to said object of the present invention apply equally to the other objects at the present invention and vice versa.

According to a preferred embodiment or to a further embodiment of the present invention, the cutting blade oscillates or rotates about its rotational axis when the cutting gap is being adjusted, in particular when the contact position is being determined as the zero position. Oscillate within the terms of the invention means that the cutting blade rotates back and forth during the adjusting operation, in a particularly preferred manner it does not perform a complete rotational movement. As claimed in the invention, it is provided in the case of said embodiment that the change in a parameter of the oscillating/rotational drive is measured when the blade contacts the cutting edge. Said parameter is preferably a lag error of the oscillating/rotational drive. Proceeding from said contact position as the zero position, the cutting blade can then be moved away from the cutting edge by a defined spacing which is just large enough such that the blade does not impact against the cutting edge or is not so large that it results in the products being chopped. Said spacing is the desired cutting gap.

The statements made with respect to said object of the present invention apply equally to the other objects of the present invention and vice versa.

The cutting blade preferably performs a helical movement at least sometimes during the adjusting of the cutting gap, i.e. it rotates/oscillates and at the same time is axially displaced until it contacts the cutting edge and/or until the desired cutting gap is adjusted.

A further or a preferred object of the present invention is a method for adjusting the cutting gap on a slicing device for cutting food products, wherein the slicing device has a rotatingly driven blade, a cutting edge and an adjusting device which moves the blade perpendicularly with respect to the cutting edge toward the cutting edge or away from said cutting edge and a change at the rotational drive of the cutting blade is measured and, as a result, the position of the cutting blade is determined in relation to the cutting edge.

The statements made with respect to said object of the present invention apply equally to the other objects of the present invention and vice versa.

In particular, in the case of said method, a change at the rotational drive of the blade can be ascertained as soon as the blade contacts the cutting edge. Proceeding from said contact position as the zero position, the cutting blade can then be moved away from the cutting edge by a defined spacing which is just large enough such that the blade does not impact against the cutting edge or is not so large that it results in the product being chopped. Said spacing is the desired cutting gap.

According to a further or a preferred object of the present invention, the change in voltage or the change in current at the drive of the adjusting device and/or at the drive of the rotational drive is determined when the blade contacts the cutting edge.

The statements made with respect to said object of the present invention apply equally to the other objects of the present invention and vice versa.

When determining the zero position, elastic deformation of the blade, which occurs when the blade contacts the cutting edge and prior to the drive being switched off, is preferably taken into consideration.

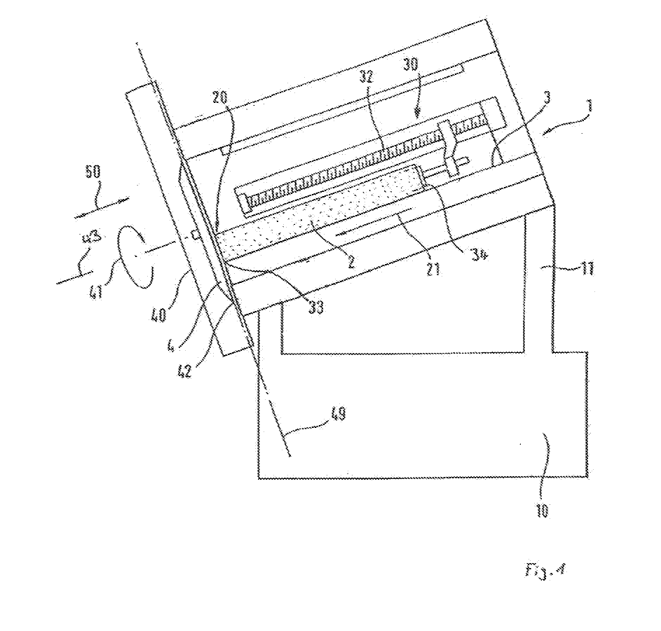

The invention is explained below by way of the single FIG. 1. Said explanations are simply by way of example and do not restrict the general inventive concept. The explanations apply equally to all objects of the present invention.

The slicing device 1 as claimed in the invention is arranged by means of a framework 11 on a support structure 10. A block of food 2, for example a block of sausage, meat or cheese, rests on the product support 3. In this connection the product support 3 is, for example, a roller conveyor and/or a conveyor belt and alloys for the food 2 to be conveyed in as smooth a manner as possible in the direction of a cutting blade 4.

In this connection, the food 2 is conveyed by a conveying device 30 in the direction of the cutting blade 4. The cutting blade can be a circular blade or a crescent-shaped blade, for example. The conveying device 30 is realized in this case, as an example, by a spindle drive 32, on which a gripper 34 is guided in the manner of a slide which is in clamp-like engagement with the rear end of the block of food. The gripper 34 is moved by the rotation of the spindle 32. The conveying movement of the spindle drive 32 is transmitted to the food 2 by the gripper 34. However, many other developments are also known and can be used for the development of the conveying device 3. The conveying of the block of food, however, can also be carried out on its own or additionally by conveyor belts which are situated below and/or above the block of food 2.

The cutting blade 4, as a rule, is situated in a cutting blade housing 40. The cutting blade 4 has a cutting blade drive (not shown in any detail here) which sets the cutting blade 4 in rotation 41. The cutting blade 4 is arranged, for example, on a planetary gearing unit and thus, along with the rotation about its axis of rotation, also carries out a rotation of the rotational axis about the axis of the planetary gearing unit. The result here is that the cutting blade 4 circulates in a periodic manner and penetrates into the food 2, for example approaching the food 2 from above, and cuts off a food slice (not shown) which then drops down onto a conveyor belt (not shown either). Through the planet-like circulating movement of the cutting blade 4, the front end 20 of the food 2 is regularly re-exposed and in said time segment, the conveying device 30 conveys the food 2 forward by the thickness of precisely one slice. However, the exposing of the front end 20 of the food 2 can also be achieved by said cutting blade being a crescent-shaped blade. In this case, there is no need for the planetary movement of the cutting head. During cutting, the cutting blade 4 acts with a cutting edge 42 which is situated, in this case, at the front end of the product support 3. As claimed in the invention, it is proposed that an adjusting device is arranged, the aim of which is to make the spacing between the cutting blade 4 and the front end 20 of the block of food 2 changeable. Said displacement of the cutting blade along its rotational axis and in relation to the cutting edge 42, in the present case, is used for adjusting the cutting gap by the cutting blade, at a spacing from the cutting edge, being moved toward said cutting edge up until the blade contacts the cutting edge. At said contact, for example the changes in the rotation of the cutting blade, for example in the form of a lag error, are then measured in order to ascertain the contact between the cutting blade and the cutting edge. As claimed in a preferred design, during the measuring process the cutting blade does not perform any full revolutions, but rather oscillates to and fro driven by the rotational drive. As an alternative to this, the blade is rotated about its rotational axis. For example, in the case of the rotational drive or oscillating drive, the occurrence or a lag moment is determined and/or a change in current consumption or a change in voltage in the rotational drive is measured. In the case of “lag moment”, the blade is rotationally driven, preferably at a low torque, and the actual position of the rotational drive is constantly compared to a required position. If the actual position deviates from the required position (=lag error), it is assumed that the blade has contacted the cutting strip and has reached the zero position. As soon as the contact between the blade and the cutting edge has been ascertained, its adjustment, in the direction of the cutting edge is preferably stopped or at least reduced and the cutting blade, proceeding from said “zero position”, is able to be moved away from the cutting edge again by a defined amount by the adjusting device. Said spacing is then the desired cutting gap. As an alternative to this or in addition to it, the lag error of the drive of the adjusting device which moves the cutting blade, in the direction of the cutting edge and away from said cutting edge is measured. In this case, the blade is moved by the adjusting device in an axial manner along its rotational axis in the direction of the cutting edge at a very small current and a low speed, in this case, the actual position of the adjusting drive is constantly compared to the required position. If the actual position deviates from the required position (=lag error), it is assumed that the blade has contacted the cutting strip and the zero position has been reached. The desired cutting gap can then be adjusted proceeding from said zero position.

### LIST OF REFERENCES

1 Slicing machine, slicer
11 Framework
2 Block of food, product
20 Front end of the block of food
3 Product support
30 Conveying device
33 Cutting edge
34 Gripper
4 Cutting blade, blade
41 Rotation of the blade
42 Cutting edge
49 Cutting plane

1. A method for adjusting the cutting gap on a slicing device for cutting food products, wherein the slicing device has a rotatingly driven blade, a cutting edge and an adjusting device which moves the blade perpendicularly with respect to the cutting edge toward the cutting edge or away from said cutting edge,
wherein the blade is first of all moved by the adjusting device until the blade contacts the cutting edge and a desired spacing between the blade and the cutting edge is then adjusted by the adjusting device, wherein a lag error
of the rotational drive of the blade and/or
of the drive of the adjusting device which moves the blade perpendicularly with respect to the cutting edge,
is determined when the blade contacts the cutting edge.

2. The method as claimed in claim 1, wherein the blade oscillates or rotates during the adjustment.

3. The method as claimed in claim 2, wherein a direction of rotation of the blade when the cutting gap is adjusted is effected in opposition to the direction of rotation of the blade during cutting.

4. The method as claimed in claim 3, wherein a change in a parameter of the oscillating or rotational drive is measured.

5. The method as claimed in claim 1, wherein during the adjustment of the cutting gap, the blade carries out a helical movement at least sometimes.

6-10. (canceled)

11. The method as claimed claim 2, wherein during the adjustment of the cutting gap, the blade carries out a helical movement at least sometimes.

12. The method as claimed claim 3, wherein during the adjustment of the cutting gap, the blade carries out a helical movement at least sometimes.

13. The method as claimed claim 4, wherein during the adjustment of the cutting gap, the blade carries out a helical movement at least sometimes.

14. A slicing device, for slicing blocks of food, in particular blocks of sausage, meat or cheese, wherein the food rests on a product support and a cutting blade, which is rotatingly driven by way of a blade shaft in cooperation with a cutting edge at the front end of the block of food, cuts off food slices, the cutting blade is situated in a cutting plane during the cutting off of the food slice, the cutting blade is mounted so as to be movable in relation to the product support and parallel to the axis of rotation of the cutting blade and there is provided a device, the aim of which is to make the spacing between the cutting blade and the front end of the block of food changeable so as to carry out one or several dead cuts and the device brings about a movement of the cutting blade in relation to the cutting edge for adjusting a cutting gap, wherein the rotational drive of the blade has a means by way of which the contact between the blade and the cutting edge is ascertainable, wherein the means is a lag error measurement.
